(19) United States
(12) Patent Application Publication
(10) Pub. No.: US 2016/0225068 A1
(43) Pub. Date: Aug. 4, 2016

(54) SUBSIDIZED RESERVE ONLINE AUCTION

(71) Applicant: GOOGLE INC., Mountain View, CA (US)

(72) Inventors: Kai Yang, Mountain View, CA (US); Martin Pal, Maplewood, NJ (US)

(21) Appl. No.: 14/609,381

(22) Filed: Jan. 29, 2015

(51) Int. Cl. G06Q 30/08

(52) U.S. Cl. CPC G06Q 30/08

(57) ABSTRACT

For a set of auction items, establishing a subsidy specification comprising an initial subsidy balance. For each auction item in the set, establishing winning bid price criteria, winning bidder criteria, and a reserve price. Receiving at least one bid. Determining a winning bid price from among the received bids according to the winning bid price criteria. For a winning bid price less than the reserve price by an amount not greater than the subsidy balance, decrementing the subsidy balance by the difference between the reserve price and the winning bid price, and awarding the auction item to the winning bidder at the winning bid price.

### TECHNICAL FIELD

The disclosed technology relates to online auctions of goods or services (hereinafter “items”) generally. Example embodiments relate to online reserve auctions with a subsidized reserve price.

### BACKGROUND

Online auctions are ubiquitous on the Internet in forms such as first-price sealed bid auctions, Vickrey auctions (“second price” auctions), and English (or “open outcry”) auctions. Such auctions can be for goods and services to be sold to consumers; and for advertising opportunities on web pages such as search engine results web pages, web banner ads on content pages, and interstitial ads such as those displayed before a user can access content.

A “reserve auction” is an auction in which the item on auction may not be sold if the no bid is enough to satisfy a “reserve price.” In some cases the reserve price is known to the seller, but not to the bidder(s). While “reserve price” is typically used to refer to a minimum acceptable price set by the seller, “minimum bid” is typically used to refer to a floor set by an auctioneer. In the present disclosure, these terms are used interchangeably. Reserve auctions are often used in selling online advertising opportunities.

### SUMMARY

The technology described herein includes computer-implemented methods, computer program products, and systems for auctioning items. In some embodiments, a subsidy specification comprising an initial subsidy balance is established. For each auction item in the set, winning bid price criteria, winning bidder criteria, and a reserve price are established. At least one bid is received. A winning bid price is determined from among the received bids according to the winning bid price criteria. For a winning bid price less than the reserve price by an amount not greater than the subsidy balance, the subsidy balance is decremented by the difference between the reserve price and the winning bid price. The auction item to the winning bidder at the winning bid price.

In some embodiments, the subsidy specification includes one or more subsidy balance expenditure condition. Decrementing and awarding in some such embodiments are performed only when the subsidy balance expenditure conditions are met. In some such embodiments, the subsidy balance expenditure conditions include one or both of a time period over which the subsidy balance may be expended, and a predetermined number of item selling opportunities over which the subsidy balance may be expended.

In some embodiments, the subsidy balance is a bidder-specific subsidy balance. In some embodiments, the initial subsidy balance is determined by optimizing an increase in revenue per unit subsidy over historical auction item selling opportunities. In some embodiments, the winning bid price criteria is a second price auction criteria. In some embodiments, the winning bid price criteria is first price auction criteria.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a communications and processing architecture for subsidized reserve online auctions, in accordance with certain example embodiments.

FIG. 2 is a block flow diagram depicting example methods for subsidized reserve online auctions, in accordance with certain example embodiments of the disclosed technology.

FIG. 3 is a block flow diagram depicting example methods for subsidized reserve online auctions, in accordance with certain example embodiments of the disclosed technology.

FIG. 4 is a block flow diagram depicting example methods for subsidized reserve online auctions, in accordance with certain example embodiments of the disclosed technology.

FIG. 5 is a block flow diagram depicting example methods for subsidized reserve online auctions, in accordance with certain example embodiments of the disclosed technology.

FIG. 6 is a block flow diagram depicting example methods for subsidized reserve online auctions, in accordance with certain example embodiments of the disclosed technology.

FIG. 7 is a diagram depicting a computing machine and a module, in accordance with certain example embodiments of the disclosed technology.

### DETAILED DESCRIPTION OF THE EXAMPLE EMBODIMENTS

### Overview

In an auction, a seller may set a reserve price. In reserve price auctions, if the reserve price is not met by at least one bid, the auction transaction is not completed. In situations where the auctioned item has a temporal characteristic, such as an opportunity to present an advertisement, the opportunity to complete the transaction (and hence to obtain revenue) may be lost. Embodiments of the present technology can allow some auction transactions to be completed, under constraints, even though the reserve price is not met.

Consider a typical ad impression auctioning exchange in which a publisher (seller) sets a floor price f for an ad slot, and the highest two bids from bidders are b1 and b2 (b2<=b1). In most cases, f is static for a given set of ad slots, but bids are dynamic, they change by every impression. For the impression to be awarded, b1>=f must be true. There are two popular ways to charge the winner: first price auction—charge winner b1; second price auction—charge winner max (f, b2). If the seller wants to sell as many ad slot impressions as possible such that there are winners for most of impressions, then the seller should lower floor price f. However, the floor price should be high enough to protect seller's brand and bring in more revenue, so the seller should increase floor price f. These two objectives contradict each other. It is desirable for the sellers to have some way flexibility with regard to floor prices based on the bidders' bids.

In embodiments of the disclosed technology, the seller still sets floor price f, additionally the sets some budget C to subsidize the otherwise winning bidders where the wining bid b1<f Note C can be a money pool to subsidize a set of impressions.

In such cases the auction proceeds as follows. When b1>=f the auction runs normally. When the b1<f, embodiments of the present technology decide whether to subsidize the winning bidder, for example subsidize the winning bidder (f−b1) to meet the floor price, charge the winning bidder the winning bid price, and update C=C (f−b1). This effectively changes floor price dynamically. In this way, when C is increased, the ads match rate is increased (i.e., more winning bids can be awarded to winning bidders), and at the same time, seller still charges the high bids (b1>=f).

Turning now to the drawings, in which like numerals represent like (but not necessarily identical) elements throughout the figures, example embodiments of the present technology are described in detail.

### Example System Architectures

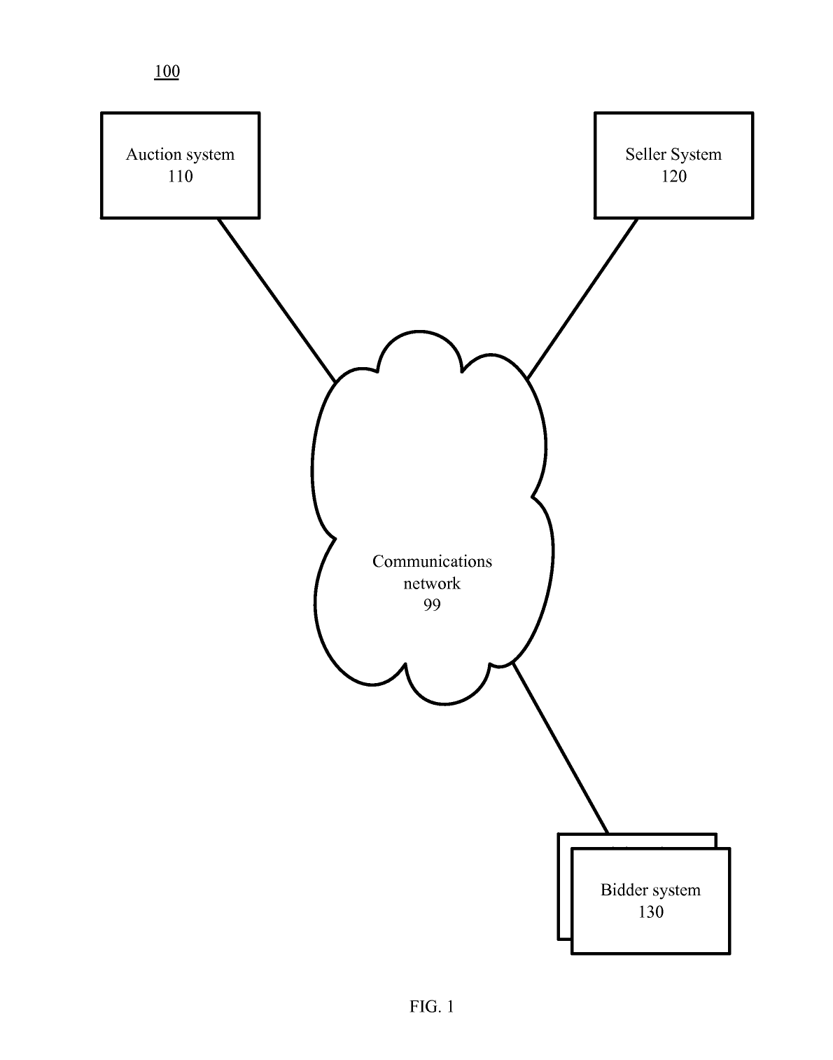

FIG. 1 is a block diagram depicting a communications and processing architecture 100 for subsidized reserve online auctions, in accordance with certain example embodiments. While some servers, systems, and devices shown in the architecture are represented by one instance of the server, system, or device, multiple instances of each can be used. Further, while certain aspects of operation of the present technology are presented in examples related to FIG. 1 to facilitate enablement of the claimed invention, additional features of the present technology, also facilitating enablement of the claimed invention, are disclosed elsewhere herein.

As depicted in FIG. 1, the architecture 100 includes network devices 110, 120, and 130; each of which may be configured to communicate with one another via communications network 99. In some embodiments, a user associated with a device must install an application and/or make a feature selection to obtain the benefits of the technology described herein.

Network 99 includes one or more wired or wireless telecommunications means by which network devices may exchange data. For example, the network 99 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, a near field communication (NFC) connection, any combination thereof, and any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network device 110, 120, and 130 can include a communication module capable of transmitting and receiving data over the network 99. For example, each network device can include a server, a desktop computer, a laptop computer, a tablet computer, a television with one or more processors embedded therein and/or coupled thereto, a smart phone, a handheld computer, a personal digital assistant (PDA), or any other wired or wireless processor-driven device. In the example embodiment depicted in FIG. 1, an auctioneer may operate user auction system 110; a seller may operate seller system 120, and a bidder may operate bidder system 130. In some embodiments, such as ad impression auctions, the auctioneer and the seller may be the same party.

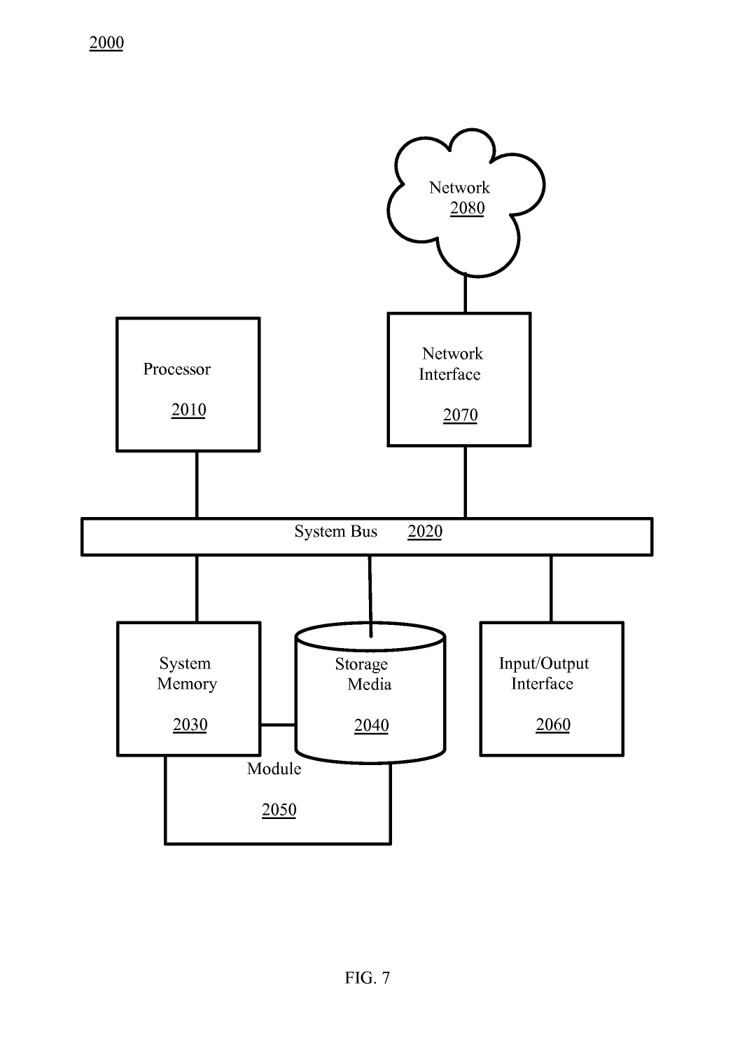

In example embodiments, the network devices, and any other computing machines associated with the technology presented herein, may be any type of computing machine such as, but not limited to, those discussed in more detail with respect to FIG. 7. Furthermore, any modules associated with any of these computing machines, such as modules described herein or any other modules (scripts, web content, software, firmware, or hardware) associated with the technology presented herein may by any of the modules discussed in more detail with respect to FIG. 7. The computing machines discussed herein may communicate with one another as well as other computer machines or communication systems over one or more networks, such as communications network 99. The communications network 99 may include any type of data or communications network, including any of the network technology discussed with respect to FIG. 7.

The network connections illustrated are example and other means of establishing a communications link between the computers and devices can be used. Moreover, those having ordinary skill in the art having the benefit of the present disclosure will appreciate that the network devices illustrated in FIG. 1 may have any of several other suitable computer system configurations. For example, bidder system 130 may be embodied as a mobile phone or handheld computer may not include all the components described above.

### Example Processes

The example methods illustrated in the following figures are described hereinafter with respect to the components of the example operating environment and example architecture described elsewhere herein. The example methods may also be performed with other systems and in other environments.

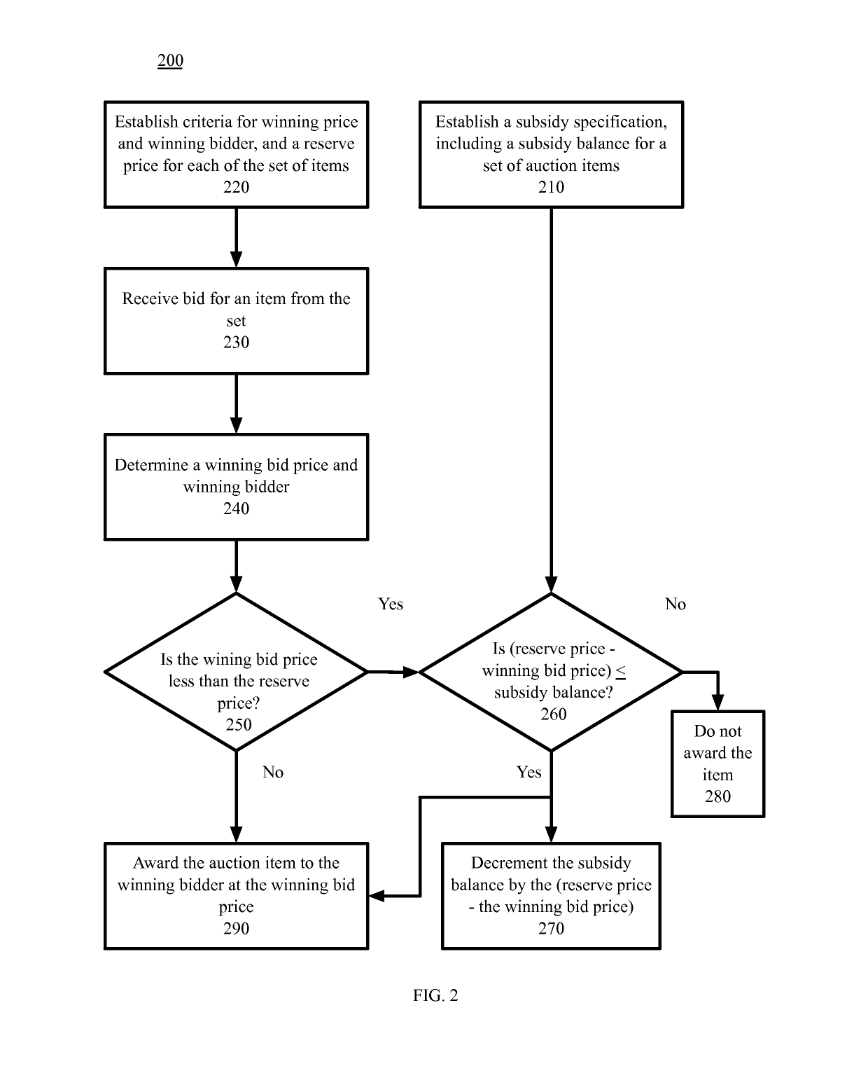

Referring to FIG. 2, and continuing to refer to prior figures for context, a block flow diagram depicting methods for subsidized reserve online auctions 200, in accordance with certain example embodiments of the disclosed technology is shown. In such methods, a subsidy specification including an initial subsidy balance is established for a set of auction items—Block 210. Consider, as a continuing example, a series of online auctions for each of a plurality of advertising opportunities. In the continuing example, seller using seller system 120 establishes an initial balance of $10 in the auction system 110.

For each item in the set a winning bid price criteria, a winning bidder criteria, and a reserve price can be established—Block 220. In the continuing example, a winning bid price criteria and winning bidder criteria are specified by the seller using the seller system 120 to direct that the auction system 110 conduct the auction as a second-price auction. The seller using seller system 120 establishes a reserve price of $5 for the first auction item in the auction system 110. In this case, the bidders are aware that the auction will be conducted as a second-price auction, but the bidders are not aware that a reserve price of $5 has been set.

At least one bid can be received for each item in the set—Block 230. In the continuing example, bids are received by auction system 110 from bidders A, B, C, D, and E, each using a bidder system 130, as shown in TABLE 1.

TABLE 1

| BIDDER | AMOUNT |
|---|---|
| A | $3.00 |
| B | $4.00 |
| C | $6.00 |
| D | $3.75 |
| E | $3.50 |

A winning bid price can be determined according to the winning bid price criteria—Block 240. In the continuing example, which is a second price auction, the winning bid price is determined by the auction system 110 to be $4—the second highest price bid in this second price auction. Also, the winning bidder is determined by the auction system 110 to be Bidder C, who bid the highest price.

For a winning bid price determined to be less than the reserve price (“yes” path from decision Block 250) by an amount not greater than the subsidy balance (“yes” path from decision Block 260), 1) the subsidy balance can be decremented by the difference between the reserve price and the winning bid price (Block 270), and 2) the auction item can be awarded to the winning bidder at the winning bid price (Block 290).

In the continuing example, the auction system 110 determines that the winning bid price of $4.00 is less than the reserve price of $5.00. The auction system further determines that the difference between the reserve price and the bid price ($1.00) is not less than the subsidy balance of $10.00. In this example, the subsidy balance is decremented by the difference ($1) to a subsidy balance of $9. Further, the auction item can be awarded to Bidder C at $4.00.

If the winning bid price is not less than the reserve price (“No” path from Block 250) then the auction item can be awarded to the winning bidder at the winning bid price. If the winning bid price is determined to be less than the reserve price (“yes” path from decision Block 250) by an amount greater than the subsidy balance (“no” path from decision Block 260), then technology can decline to award the item—Block 280.

In a first variation on the continuing example, if the winning bid price had been determined by the auction system 110 to be $4.00 (leaving a difference of $1.00 between the winning bid price and the reserve price), yet the subsidy balance was $0.75 (leaving the difference greater than the subsidy balance), then the item would not be awarded.

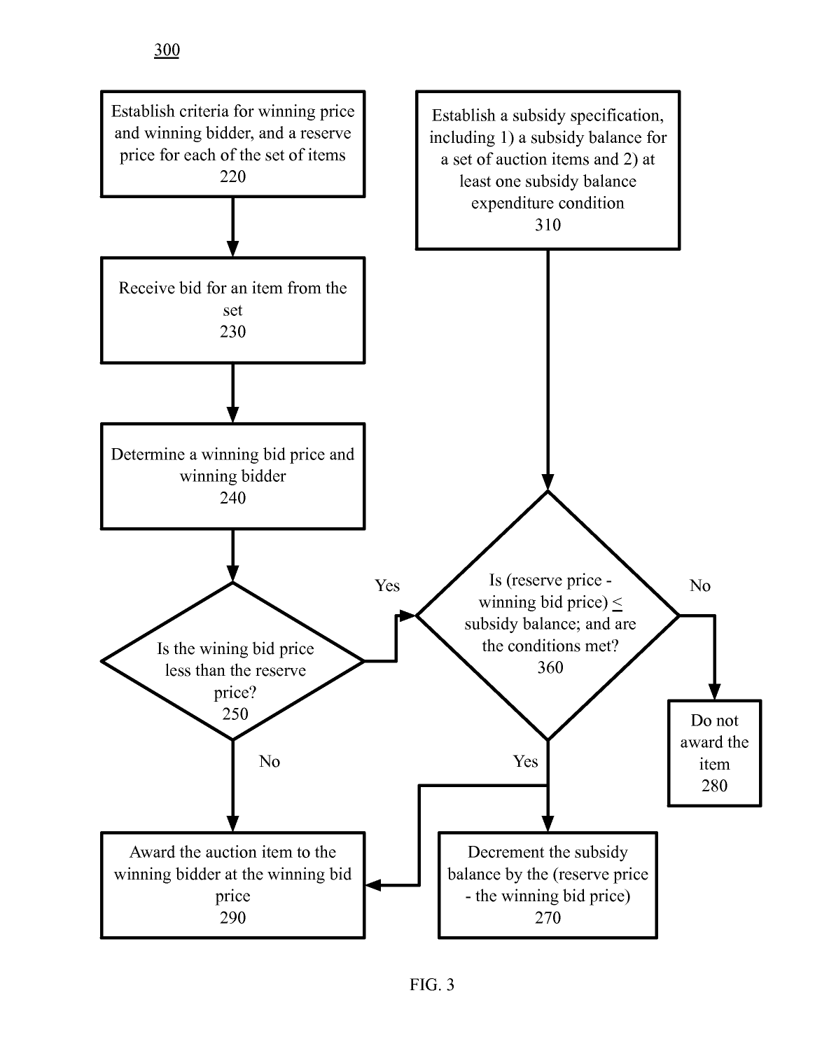

Referring to FIG. 3, and continuing to refer to prior figures for context, a block flow diagram depicting methods for subsidized reserve online auctions 300, in accordance with certain example embodiments of the disclosed technology is shown. In such methods, Blocks 220-250 and 270-290 are performed as describe in connection with FIG. 2. In such methods, a subsidy specification including both an initial subsidy balance, and at least one subsidy balance expenditure condition (other than that the subsidy balance is not less than a difference between the reserve price and a winning bid price) is established for a set of auction items—Block 310.

As a second variation on the continuing example, consider that a winning bid price criteria and winning bidder criteria are specified by the seller using the seller system 120 to direct that the auction system 110 conduct the auction as a second-price auction. The seller using seller system 120 establishes a reserve price of $5 for the first auction item in the auction system 110. In this case, the bidders are aware that the auction will be conducted as a second-price auction, but the bidders are not aware that a reserve price of $5 has been set. As a subsidy balance expenditure condition, the seller (using seller system 120) specifies to the auction system 110 that no single subsidy can be over $0.99.

In such embodiments, the system determines whether both 1) the difference between the reserve price and the winning bid price is less than the subsidy balance, and 2) the other subsidy balance expenditure conditions are met—Block 360. In the second variant of the continuing example, while condition 1) is met and leaves a required subsidy of $1.00 for this auction, condition 2) is not met, because the condition that the subsidy required for this auction not exceed $0.99 is not met. Consequently, per the “No” path from Block 360, the item would not be awarded (Block 280). Had the difference between the reserve price and the winning bid price been $0.99, then the “Yes” path from Block 260 could have been followed, the subsidy balance could have been decremented by the difference (now equal to the remaining subsidy balance), and the item could have been awarded to the winning bidder at the winning price.

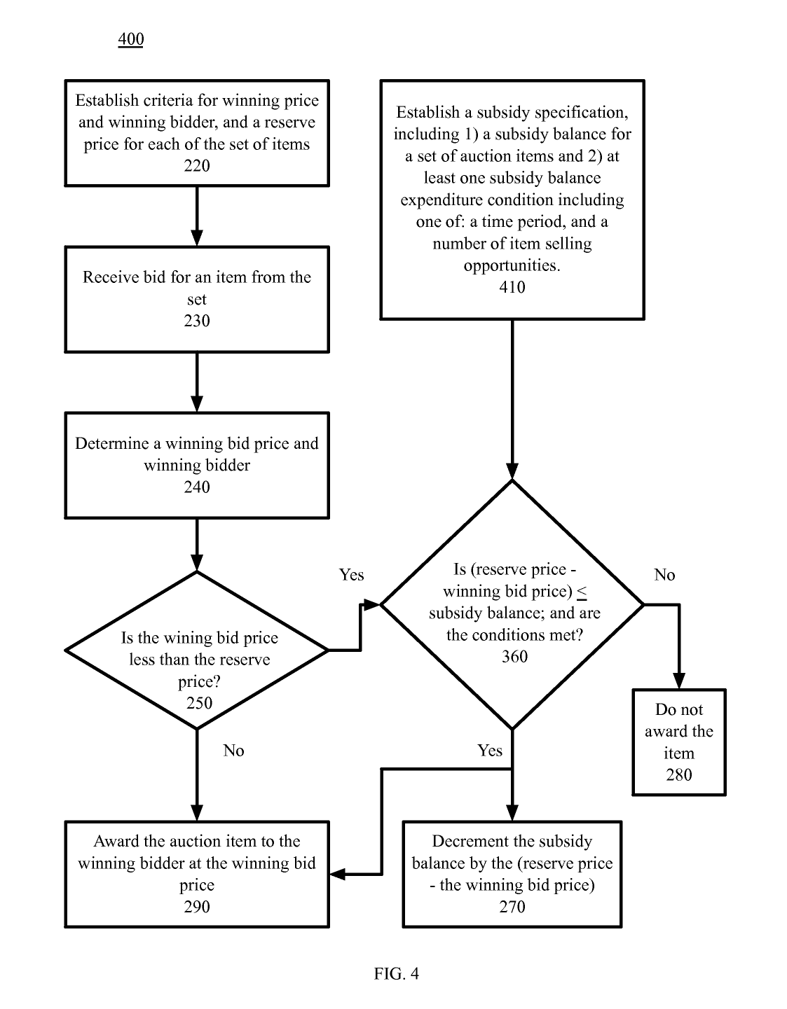

Referring to FIG. 4, and continuing to refer to prior figures for context, a block flow diagram depicting methods for subsidized reserve online auctions 400, in accordance with certain example embodiments of the disclosed technology is shown. In such methods, Blocks 220-250, 360, and 270-290 are performed as describe in connection with FIG. 2. In such methods the subsidy specification includes a subsidy balance expenditure condition regarding at least one of a time period and a number of selling opportunities—Block 410. The time period can be measure from a point such as, but not limited to, the time the first item of the set of items is offered for sale, the time the first bid is received, the first time a determination whether there is sufficient subsidy balance to support a transaction, and the time the first subsidy is applied. The number of selling opportunities can be counted from each the first set of bids to be assessed, or from the first awarded bid counting only awarded bids, for example.

In a third variant of the continuing example, the seller uses seller system 120 to establish a limit of 100 auctions as a subsidy balance expenditure condition in addition to limiting the maximum subsidy to $1.00. For example, a seller could allocate $10.00 of a promotional budget to selling 100 units. Instead of giving $0.10 off every unit (without knowing the specific of demands for the unit), the seller can make $10.00 available to subsidize the purchase where the winning bid price does not meet the reserve price. This approach has the advantage that if a total of $10.00 is not needed to subsidize the difference between the reserve price and the winning price, then the seller has saved the amount of subsidy not needed.

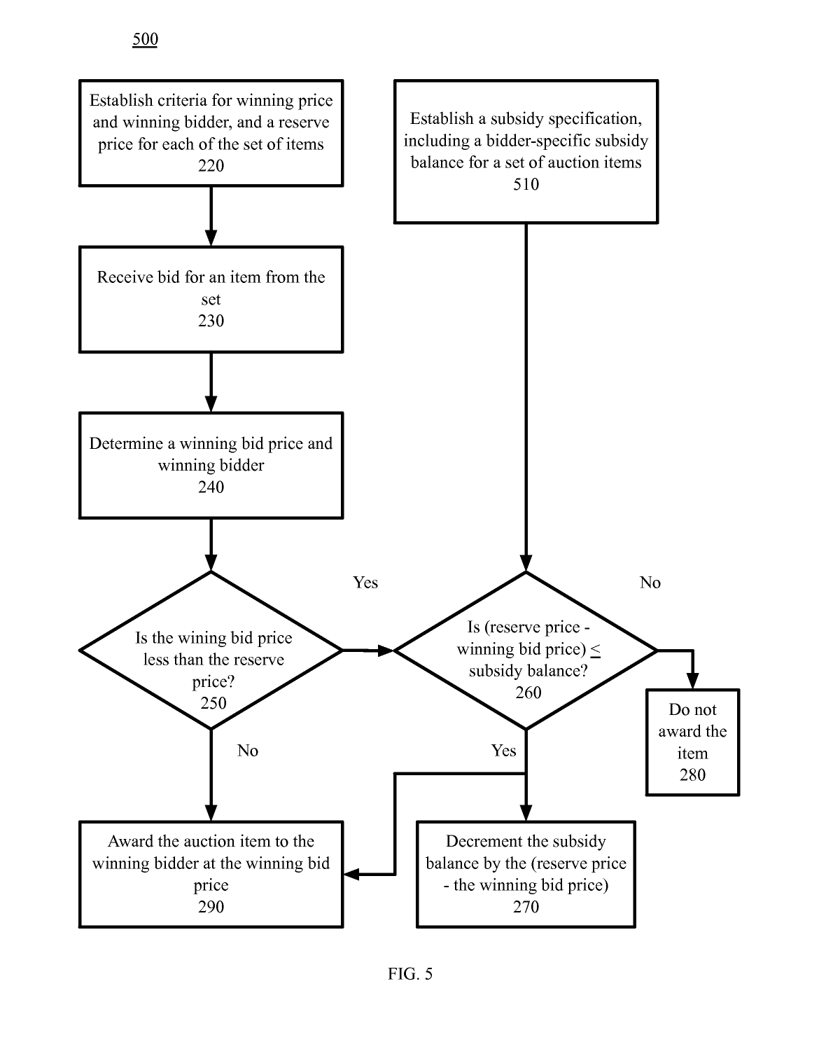

Referring to FIG. 5, and continuing to refer to prior figures for context, a block flow diagram depicting methods for subsidized reserve online auctions 500, in accordance with certain example embodiments of the disclosed technology is shown. In such methods, Blocks 220-290 are performed as describe in connection with FIG. 2. In such methods, a subsidy balance is established that includes at least a seller-specific or a bidder-specific subsidy balance—Block 510. Using a bidder-specific subsidy balance can allow a seller to control the subsidies used on a bidder-by-bidder basis.

For example, a ticket vendor, selling thousands of tickets to an event, can omit a total ticket limit per bidder, and establish the face price of the ticket as the reserve price. Any tickets beyond the first ticket purchased by the bidder can carry a negative subsidy with no limit on the total negative subsidy to discourage, but not prevent, ticket hoarding.

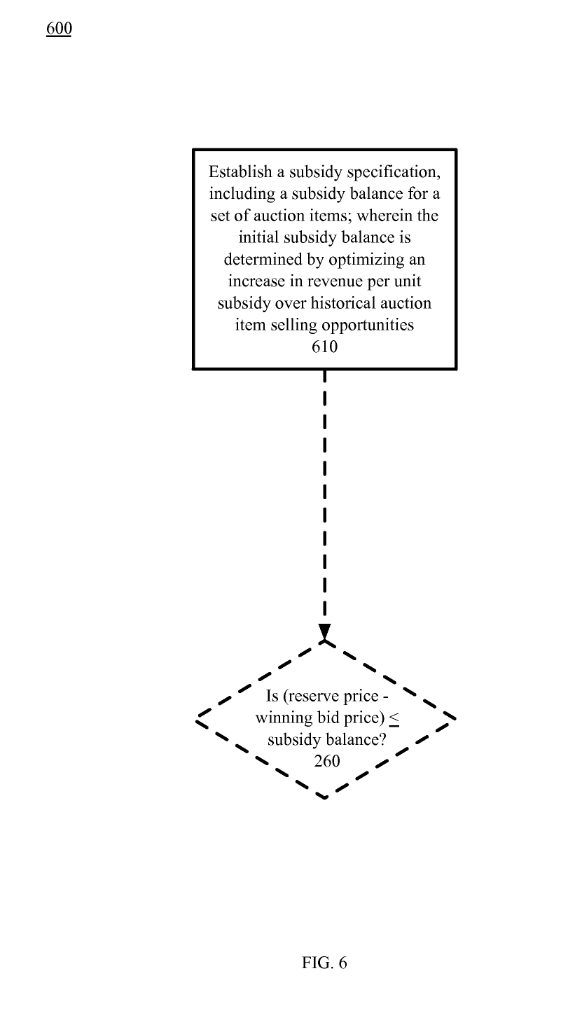

Referring to FIG. 6, and continuing to refer to prior figures for context, a block flow diagram depicting methods for subsidized reserve online auctions 600, in accordance with certain example embodiments of the disclosed technology is shown. In such methods, Blocks 220-290 are performed as describe in connection with FIG. 2. In such methods, the initial subsidy balance is determined by optimizing an increase in revenue per unit subsidy over historical auction item selling opportunities—Block 610.

For example, after using each of a set of uniformly spaced subsidies on each of 100 auctions including a zero-subsidy control group of 100 auctions, an initial subsidy balance can be computed by selecting the subsidy providing the best increase in total revenue per subsidy unit.

As a further example using historical data to determine a maximum amount to subsidize any given auction, consider using data from the previous day to compute today's threshold t. First sort yesterday's differences between the reserve price and the winning bid price (for bid prices below the reserve price) d in ascending order: d1, d2, d3. Then t=max {dj: sum (d1, d2, . . . dj)<=C}.

As an explanation of how this is effective, suppose that the seller has decided to use an amount C of total subsidy to increase the number of impressions sold to a bidder. Assume a fixed floor price f Suppose that the system has access to historical bidding data for the bidder, and are able to forecast the distribution of bids from this bidder for the next budgeting period, such as the next day. Let be the b1≧b2≧ . . . ≧bn set of bids less than f the bidder is predicted make. One objective is to maximize the total revenue from those bids subject to the constraint that the total amount of subsidy doesn't exceed C.

The problem can be written formally as max Σ_{iεS} bᵢ, subject to Σ_{iεs}(f−bᵢ)≦C, where the maximization is taken over possible subsets of S⊂{1, . . . n}. The optimal solution turns out to be a prefix of highest bids (bids with lowest required subsidy). Equivalently, such prefix can be described by a threshold (“take all bids b>f−t”) where the optimal threshold t is given by the formula above t=max {dj: sum (d1, d2, dj)<=C}.

### OTHER EXAMPLE EMBODIMENTS

FIG. 7 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components, for example, a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories, for example, read-only memory (ROM), programmable read-only memory (PROM), erasable programmable read-only memory (EPROM), flash memory, or any other device capable of storing program instructions or data with or without applied power. The system memory 2030 may also include volatile memories, for example, random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device, for example, the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid sate drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules, for example, module 2050, data, or any other information. The storage media 2040 may be part of, or connected to, the computing machine 2000. The storage media 2040 may also be part of one or more other computing machines that are in communication with the computing machine 2000, for example, servers, database servers, cloud storage, network attached storage, and so forth.

The module 2050 may comprise one or more hardware or software elements configured to facilitate the computing machine 2000 with performing the various methods and processing functions presented herein. The module 2050 may include one or more s of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits, for example, microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, for example, small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media, for example, fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device, for example, a system on chip (SOC), system on package (SOP), or ASIC device.

In situations in which the technology discussed here collects personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (for example, to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the technology described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

We claim:

1. A computer-implemented method for auctioning items, comprising:
for a set of auction items, establishing, by one or more computing devices, a subsidy specification comprising an initial subsidy balance;
for each auction item in the set:
establishing, by the one or more computing devices, a winning bid price criteria, a winning bidder criteria, and a reserve price;
receiving, by the one or more computing devices, at least one bid;
determining, by the one or more computing devices, a winning bid price from among the received bids according to the winning bid price criteria;
for a winning bid price less than the reserve price by an amount not greater than the subsidy balance:
decrementing, by the one or more computing devices, the subsidy balance by the difference between the reserve price and the winning bid price; and
awarding, by the one or more computing devices, the auction item to the winning bidder at the winning bid price.

2. The method of claim 1, wherein:
the subsidy specification comprises one or more subsidy balance expenditure conditions; and
the decrementing and the awarding are performed only when the subsidy balance expenditure conditions are met.

3. The method of claim 2, wherein the one or more subsidy balance expenditure conditions comprise at least one of:
a time period over which the subsidy balance may be expended; and
a predetermined number of item selling opportunities over which the subsidy balance may be expended.

4. The method of claim 1, wherein the subsidy balance is a bidder-specific subsidy balance.

5. The method of claim 1, wherein the initial subsidy balance is determined by optimizing an increase in revenue per unit subsidy over historical auction item selling opportunities.

6. The method of claim 1, wherein the winning bid price criteria is a second price auction criteria.

7. The method of claim 1, wherein the winning bid price criteria is first price auction criteria.

8. A computer program product, comprising:
a non-transitory computer-readable storage device having computer-executable program instructions embodied thereon that when executed by a computer cause the computer to auction items, the computer-executable program instructions comprising:
computer-executable program instructions to establish, for a set of auction items, a subsidy specification comprising an initial subsidy balance;
for each auction item in the set:
computer-executable program instructions to establish a winning bid price criteria, a winning bidder criteria, and a reserve price;
computer-executable program instructions to receive at least one bid;
computer-executable program instructions to determine a winning bid price from among the received bids according to the winning bid price criteria;
for a winning bid price less than the reserve price by an amount not greater than the subsidy balance:
computer-executable program instructions to decrement the subsidy balance by the difference between the reserve price and the winning bid price; and
computer-executable program instructions to award the auction item to the winning bidder at the winning bid price.

9. The computer program product of claim 8, wherein:
the subsidy specification comprises one or more subsidy balance expenditure conditions; and
the decrementing and the awarding are performed only when the subsidy balance expenditure conditions are met.

10. The computer program product of claim 9, wherein the one or more subsidy balance expenditure conditions comprise at least one of:
a time period over which the subsidy balance may be expended; and
a predetermined number of item selling opportunities over which the subsidy balance may be expended.

11. The computer program product of claim 8, wherein the subsidy balance is a bidder-specific subsidy balance.

12. The computer program product of claim 8, wherein the initial subsidy balance is determined by optimizing an increase in revenue per unit subsidy over historical auction item selling opportunities.

13. The computer program product of claim 8, wherein the winning bid price criteria is a second price auction criteria.

14. The computer program product of claim 8, wherein the winning bid price criteria is first price auction criteria.

15. A system to auction items, the system comprising:
a storage device; and
a processor communicatively coupled to the storage device, wherein the processor executes application code instructions that are stored in the storage device to cause the system to:
establish, for a set of auction items, a subsidy specification comprising an initial subsidy balance;
for each auction item in the set:
establish a winning bid price criteria, a winning bidder criteria, and a reserve price;
receive at least one bid;
determine a winning bid price from among the received bids according to the winning bid price criteria;
for a winning bid price less than the reserve price by an amount not greater than the subsidy balance:
decrement the subsidy balance by the difference between the reserve price and the winning bid price; and
award the auction item to the winning bidder at the winning bid price.

16. The system of claim 15, wherein:
the subsidy specification comprises one or more subsidy balance expenditure conditions; and
the decrementing and the awarding are performed only when the subsidy balance expenditure conditions are met.

17. The system of claim 9, wherein the one or more subsidy balance expenditure conditions comprise at least one of:
a time period over which the subsidy balance may be expended; and
a predetermined number of item selling opportunities over which the subsidy balance may be expended.

18. The system of claim 15, wherein the subsidy balance is a bidder-specific subsidy balance.

19. The system of claim 15, wherein the initial subsidy balance is determined by optimizing an increase in revenue per unit subsidy over historical auction item selling opportunities.

20. The system of claim 15, wherein the winning bid price criteria is a second price auction criteria.
